(19) United States
(12) Patent Application Publication
(10) Pub. No.: US 2025/0377174 A1
(43) Pub. Date: Dec. 11, 2025

(54) HEAT EXCHANGER OF AN ELECTRICAL AND/OR ELECTRONIC ELEMENT FOR A MOTOR VEHICLE

(71) Applicant: VALEO SYSTEMES THERMIQUES, La Verriere (FR)

(72) Inventors: Jean Damien MULLER, La Verriere (FR); Mohamed IBRAHIMI, La Verriere (FR)

(73) Assignee: VALEO SYSTEMES THERMIQUES, La Verriere (FR)

(21) Appl. No.: 18/712,848

(22) PCT Filed: Nov. 17, 2022
(86) PCT No.: PCT/EP2022/082304

§ 371 Date: Sep. 6, 2024

(30) Foreign Application Priority Data
Nov. 26, 2021 (FR) FR2112562

(51) Int. Cl. F28F 3/04; F28D 21/00

(52) U.S. Cl. CPC F28F 3/044; F28D 2021/0028; F28D 2021/008; F28F 2250/00

(57) ABSTRACT

The invention relates to a heat exchanger for the thermal management of an electrical and/or electronic element, advantageously of a vehicle, including a heat exchange body having: a heat exchange wall intended to be in thermal contact with the electrical and/or electronic element, —a base wall opposite the heat exchange wall, a flow channel for a heat-transfer fluid formed between the heat exchange wall and the base wall, the flow channel including: a first zone having a first heat-transfer-fluid flow disruption component, a second zone having a second heat-transfer-fluid flow disruption component, the first heat-transfer-fluid flow disruption component consisting of a plurality of local deformations on the base surface and the second heat-transfer-fluid flow disruption component consisting of a fin arranged between the heat exchange surface and the base surface and forming a plurality of flow paths.

The field of the present invention relates to the thermal regulation of an electrical and/or electronic element and, more specifically, the present invention relates to an exchanger for the thermal regulation of an electrical and/or electronic element intended for electric or hybrid motor vehicles.

The electrical and/or electronic elements may for example be batteries, electronic power devices, or computer servers.

Electric and hybrid vehicles are commonly equipped with a battery. Such an electrical and/or electronic element is formed by an assembly of electric modules, which are formed by an assembly of electrochemical cells.

In order to ensure the autonomy, performance and reliability of such an electrical and/or electronic element, the electrical and/or electronic element usually needs to be thermally regulated. Thermal management of the electrical and/or electronic element is intended to keep the temperature of the constituent electric modules thereof at a temperature approximately between 20° C. and 40° C. This is because the capacity of the electrochemical cells of an electric module is reduced when the temperature of said electric module is too low, and the service life of the electrochemical cells of an electric model is degraded when the temperature of said electric module is too high. To provide such thermal management, it is known to use a thermal management device that comprises at least one heat exchanger directly in contact with an electric module of the electrical and/or electronic element and through which a heat-transfer fluid passes. In order for the heat-transfer fluid to circulate, the heat exchanger or exchangers are traversed by a thermal exchange circuit formed, for example, by ducts provided in the one or more heat exchangers themselves.

Electrical and/or electronic elements, whether they are electrical energy storage cells, integrated circuits, servers, data centers, etc., require thermal regulation in order to keep them within their operating temperature range.

The invention is in particular intended to be fitted to motor vehicles, in particular electric or hybrid motor vehicles, and to thermally regulate an electrical energy storage cell or electronic power elements.

As the market share represented by electric vehicles continues to grow, the dielectric/heating problems of the battery packs with which they are equipped are taking on strategic importance. The objective is to design the best-performing, most efficient and economical battery thermal management device possible.

A typical problem with these heat exchangers is the non-uniform dissipation of the heat along the heat exchanger. This is because the heat-transfer fluid passing through the heat exchanger heats up along the channel by absorbing calories from the electrical and/or electronic element to be cooled. The same is true where the fluid is used to heat the electrical and/or electronic element, with the fluid cooling in contact with the element to be heated. This means that the heat exchange capacity between the inlet and the outlet of a heat exchanger is different and the cooling or heating of the electrical and/or electronic element is impaired.

As a general rule, in the field of electric batteries for example, there should not be a temperature difference of more than 10° C. between the first and last cells in an electric battery module, to ensure optimum operation thereof. It must therefore be possible for the temperature difference between the part of the element or the element close to the heat-transfer fluid inlet and the part of the element or the element close to the heat-transfer fluid outlet to be kept small.

One of the objectives of the present invention is to at least partially overcome the drawbacks in the prior art and to propose a heat exchanger able to limit the impact of the temperature difference of the heat-transfer fluid observed between the inlet and the outlet of the heat exchanger on the thermal management of the electrical and/or electronic element.

The invention notably applies to circulation inside an I-shaped exchanger or to a plurality of loops connected in parallel inside the same exchanger.

The present invention therefore relates to a heat exchanger for the thermal management of an electrical and/or electronic element, advantageously of a vehicle, comprising a heat exchange body having:
a heat exchange surface intended to be in thermal contact with the electrical and/or electronic element,
a base surface opposite the heat exchange surface,
a flow channel for a heat-transfer fluid formed between the heat exchange surface and the base surface,
the flow channel comprising:
a first zone having first heat-transfer-fluid flow disruption means,
a second zone having second heat-transfer-fluid flow disruption means, the first flow disruption means consisting of a plurality of local deformations of the base surface and the second flow disruption means consisting of a fin arranged between the heat exchange surface and the base surface and forming a plurality of flow paths.

The invention provides a heat exchanger comprising zones having different heat exchange coefficients. The heat exchanger therefore provides a more uniform heat exchange for the electrical and/or electronic element or elements by lessening the impact of the temperature of the heat-transfer fluid. This is because, by enabling an increase in the disruption of the flow and of the exchange surface with the fluid, the fin in the second zone of the flow channel significantly increases the heat exchange coefficient of the second zone in relation to the heat exchange coefficient of the first zone of the flow channel.

Advantageously, the heat exchange wall is flat so as to provide a heat exchange surface enabling good thermal contact with the electrical and/or electronic element to be thermally regulated.

The heat exchange wall is intended to be in thermal contact with, or opposite, an element to be thermally regulated.

The heat-transfer fluid intended to circulate in the heat exchanger may be a refrigerant fluid (1234YF, 134a or R744 for example) or a cooling liquid (for example glycol water).

“Average hydraulic diameter” means the average hydraulic diameter over the entire length of the flow channel of a zone.

The invention may also comprise any one of the additional features listed below, individually or in combination with one another, where technically compatible with one another:
The second flow disruption means is able to generate turbulence in the flow of the heat-transfer fluid greater than the turbulence generated by the first flow disruption means, and therefore the second zone has a higher heat exchange coefficient than the first zone,
The first zone has a first average hydraulic diameter and the second zone has a second average hydraulic diameter,
The first zone and the second zone have the same average hydraulic diameter,
The second average hydraulic diameter is greater than the first average hydraulic diameter. “Average hydraulic diameter” means the average hydraulic diameter over the entire length of the flow channel of a zone,
Thus, by combining the increase of the hydraulic diameter and the increase of the flow disruption generated by the flow disruption means, it is possible to increase the heat exchange coefficient of the second zone in relation to the first zone, thereby limiting the impact of the temperature increase in the heat-transfer fluid on the temperature of the electrical and/or electronic element to be thermally regulated.
the base wall comprises, in the first zone of the flow channel, local deformations, or protuberances, and undeformed parts, the ratio between the deformations and the undeformed parts by cm² in the first zone is constant over the whole of the first zone,
the base wall comprises, in the first zone of the flow channel, local deformations, or protuberances, and undeformed parts, the ratio between the deformations and the undeformed parts by cm² in the first zone is variable, advantageously increasing along the whole of the first zone,
each deformation has a height H extending between the undeformed parts of the base wall and a top, the top advantageously being separated by a non-zero distance d from the heat exchange wall, i.e. the height H of the deformation is strictly less than the height of the channel.
the distance d being identical for all of the deformations of a given zone, where the height Hc of the channel increases, the height H of the protuberance increases identically so as to maintain the same distance d between the top of the protuberances and the heat exchange wall,
the height H of the deformations being identical for all of the deformations in a given zone,
the fin may be an offset-strip fin, a louver fin, a straight fin or a corrugated fin,
the first and second zones are directly contiguous or separated by a transition zone,
advantageously, where the flow disruption means is a fin, the hydraulic diameter is constant over the whole of a given zone,
the flow channel extends between an inlet and a fluid outlet,
the heat exchange body has a plurality of flow channels, each channel comprising its own inlet and its own outlet or at least a plurality of channels share a common inlet and an outlet, for example in communication with a supply chamber supplying the channels and a drainage chamber draining the fluid to the outlet,
the heat exchange wall is a first plate and the base wall is a second plate, the channel being formed by at least one deformation of the second plate, thereby forming a space between the heat exchange wall and the base wall, the space forming the flow channel, the deformations of the first zone consisting of local deformations of the part of the base wall forming the channel. In other words, the deformations of the first zone consist of deformations of a general pattern of the base wall in the first zone of the channel.
the fin is assembled between the first plate and the second plate,
the heat exchanger is made of metal, advantageously aluminum, and for example assembled by laser welding or brazing,
the increase in the hydraulic diameter along the channel is applied continuously,
the height and/or the width of the channel is increased to increase the hydraulic diameter,
the hydraulic diameter of the first and second zones is different, advantageously the hydraulic diameter is constant along each zone, and the first and second zones are separated from one another by a transition zone,
the first zone covers between 50% and 80% of the total length of the channel, advantageously approximately 70%.
the first zone of the flow channel comprises a fluid inlet, a supply chamber and a plurality of lines, the supply chamber supplying the plurality of lines, according to a first embodiment, each line opening directly into the second zone, according to another embodiment, each line opening into the transition zone,
The flow channel extends between an inlet and a fluid outlet, advantageously the first zone is on the inlet side and the second zone is on the outlet side in the case of an exchanger intended to cool an electrical and/or electronic element, and for a heat exchanger intended to heat an electrical and/or electronic element the first zone is arranged on the outlet side and the second zone is arranged on the inlet side.
The heat exchange body comprises a supply line supplying a plurality of flow channels, and a drainage line draining the fluid coming from the flow channels, each flow channel being connected to the supply line via the inlet thereof, and to the drainage line via the outlet thereof.

The invention also relates to a housing comprising a plurality of walls forming an internal seat and a heat exchanger as described above and advantageously assembled inside the internal seat. The housing advantageously comprises an electrical and/or electronic element assembled in thermal contact with the heat exchanger.

Naturally, the features described in relation to the different embodiments may be combined provided that they are not technically or structurally incompatible when combined.

Further features and advantages of the invention will become more clearly apparent on reading the following description, which is given by way of non-limiting illustrative example, and from the appended drawings, in which:

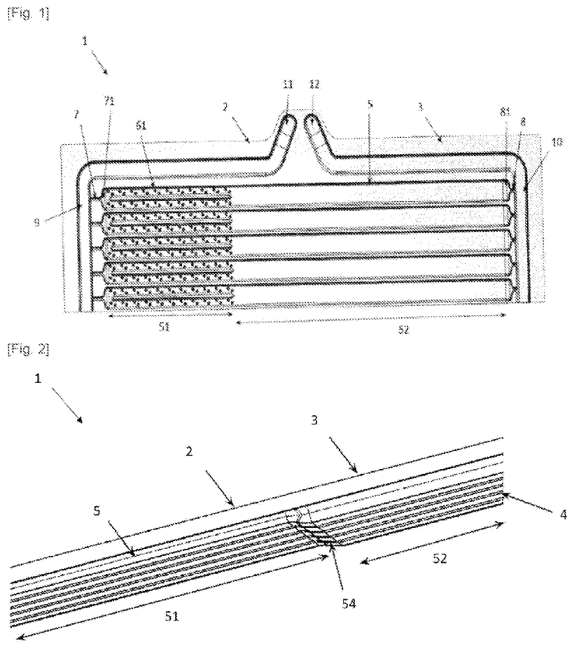

FIG. 1 is a schematic view of the heat exchanger according to a first embodiment of the invention,

FIG. 2 is a side view of a third embodiment of the invention,

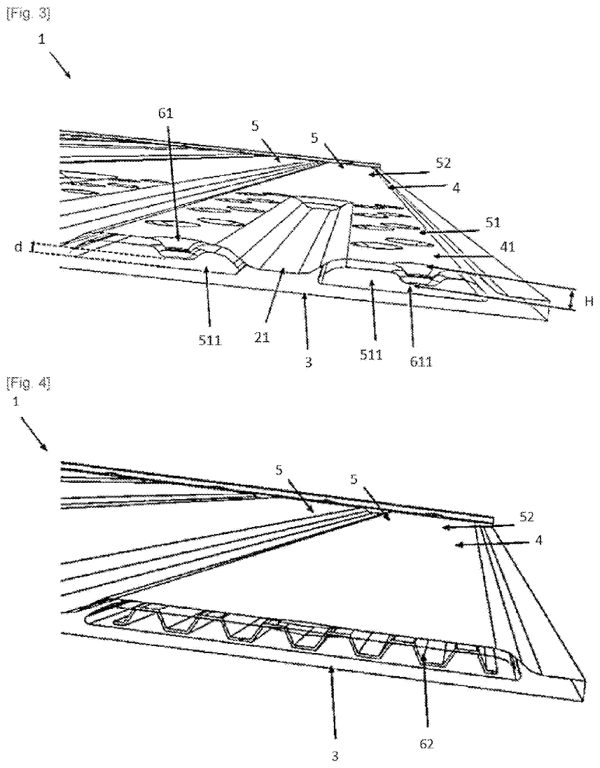

FIG. 3 shows the exchanger from FIG. 1 in cross section along a plane AA′,

FIG. 4 shows the exchanger from FIG. 1 in cross section along a plane BB′.

In the various figures, identical elements bear the same reference numbers.

The following embodiments are examples. Although the description refers to one or more embodiments, this does not necessarily mean that each reference sign refers to the same embodiment, or that the features apply only to one embodiment. Individual features of various embodiments may also be combined in order to provide other embodiments.

In the present description, some elements or parameters may be indexed, such as, for example, first zone or second zone, and also first parameter and second parameter or else first criterion and second criterion, etc. In this case, the indexing is simply to differentiate between, and denote, elements or parameters or criteria that are similar, but not identical. This indexing does not imply priority being given to one element, parameter or criterion over another, and such designations can be easily interchanged without departing from the scope of the present description. Neither does this indexing imply any chronological order for example in assessing any given criterion.

Since FIG. 1 is a bottom view, only the base wall is visible, the heat exchange wall being opposite the base wall and not shown in this figure.

FIG. 1 shows a first embodiment of the invention in which the heat exchanger 1 comprises a heat exchange body 2 having:
a heat exchange wall 3 (not shown in this figure) intended to be in thermal contact with the electrical and/or electronic element,
a base wall 4 opposite the heat exchange wall,
a flow channel 5 for a heat-transfer fluid formed between the heat exchange wall and the base wall,
   the flow channel comprising:
a first zone 51 having first heat-transfer-fluid flow disruption means 61,
a second zone having second heat-transfer-fluid flow disruption means 62, the first flow disruption means 61 consisting of a plurality of local deformations of the base surface and the second flow disruption means 62 consisting of a fin arranged between the heat exchange surface and the base surface and forming a plurality of flow paths.

The heat exchange body 2 comprising a plurality of flow channels 5, each one extending between an inlet 7 and an outlet 8. Each flow channel 5 therefore comprising an inlet 7, a supply chamber 71, two lines 511, a drainage chamber 81 and an outlet 8. Each of these channels is connected via the inlet 7 thereof to a supply line 9 and via the outlet thereof to a drainage line 10. The supply line comprises a supply opening 11 and the drainage line comprises a drainage opening 12, the openings 11 and 12 being intended to be connected to a heat-transfer fluid circulation circuit. Each of the embodiments may comprise a supply line and a drainage line as shown in FIG. 1.

The flow channel 5 has two lines 511 that are parallel and fluidtight in relation to each other along the first zone 51. The heat exchange body 2 comprising a separator 21 to separate the lines 511 from one another. The lines 511 opening into the second zone 52 of the flow channel 5.

FIG. 2 shows an embodiment in which the hydraulic diameter is constant along each zone 51, 52, the second hydraulic diameter being greater than the first hydraulic diameter and the first zone 51 and the second zone 52 are separated from one another by a transition zone 54. The transition zone 54 being a zone of variable hydraulic diameter in the direction of the flow passing from the first hydraulic diameter to the second hydraulic diameter.

FIG. 3 shows the exchanger from FIG. 1 in cross section along a plane AA′.

The first zone 51 comprises two lines 511 that are fluidtight in relation to each other and separated by a separator 21. According to one embodiment, the separator is a fluidtight contact zone between a plate forming the base wall 4 and a plate forming the heat exchange wall 3.

Each deformation 61 has a height H extending between the undeformed parts 41 of the base wall and a top 611 of the deformation 61, advantageously the top 611 being separated by a non-zero distance d from the heat exchange wall 3,

FIG. 4 shows an exchanger according to the embodiment in FIG. 1, in cross section along a plane BB′.

FIG. 4 specifically shows the inside of the flow channel 5 in the second zone 52. The flow channel 5 comprising a fin 62 between the base wall 4 and the heat exchange wall 3. The fin 62 being assembled between a plate forming the heat exchange wall 3 and a plate forming the base wall 4.

What is claimed is:

1. A heat exchanger for the thermal management of an electrical and/or electronic element, comprising a heat exchange body having:
a heat exchange surface intended to be in thermal contact with the electrical and/or electronic element,
a base surface opposite the heat exchange surface,
a flow channel for a heat-transfer fluid formed between the heat exchange surface and the base surface,
the flow channel including:
a first zone having a first heat-transfer-fluid flow disruption component,
a second zone having a second heat-transfer-fluid flow disruption component,
the first heat-transfer-fluid flow disruption component consisting of a plurality of local deformations of the base surface and the second heat-transfer-fluid flow disruption component consisting of a fin arranged between the heat exchange surface and the base surface and forming a plurality of flow paths.

2. The heat exchanger as claimed in claim 1, wherein the second heat-transfer-fluid flow disruption component is able to generate turbulence in the flow of the heat-transfer fluid greater than the turbulence generated by the first heat-transfer-fluid flow disruption component and the second average hydraulic diameter is greater than the first average hydraulic diameter.

3. The heat exchanger as claimed in claim 2, wherein the base wall includes the deformations and undeformed parts between each deformation, the ratio of deformations to undeformed parts by cm² of the first zone may be constant or variable along the first zone.

4. The heat exchanger as claimed in claim 3, wherein each deformation has a height H and a top separated by a non-zero distance d from the heat exchange wall.

5. The heat exchanger as claimed in claim 1, wherein the heat exchange wall is a first plate and the base wall is a second plate, the flow channel being formed by at least one deformation of the second plate.

6. The heat exchanger as claimed in claim 1, wherein the hydraulic diameter increases regularly along the first zone of the channel and/or the second zone.

7. The heat exchanger as claimed in claim 1, wherein the hydraulic diameter is constant along each zone, and the first zone and the second zone are separated from one another by a transition zone.

8. The heat exchanger as claimed in claim 1, wherein the first zone covers between 50% and 80% of the total length of the channel.

9. The heat exchanger as claimed in claim 1, wherein the flow channel includes a plurality of lines that are parallel to one another in the first zone.

10. A housing comprising a plurality of walls forming an internal seat and a heat exchanger including a heat exchange body having:
a heat exchange surface intended to be in thermal contact with the electrical and/or electronic element,
a base surface opposite the heat exchange surface,
a flow channel for a heat-transfer fluid formed between the heat exchange surface and the base surface,
the flow channel including:
a first zone having a first heat-transfer-fluid flow disruption component,
a second zone having a second heat-transfer-fluid flow disruption component,
the first heat-transfer-fluid flow disruption component consisting of a plurality of local deformations of the base surface and the second heat-transfer-fluid flow disruption component consisting of a fin arranged between the heat exchange surface and the base surface and forming a plurality of flow paths.

11. The heat exchanger as claimed in claim 1, wherein the second heat-transfer-fluid flow disruption component is able to generate turbulence in the flow of the heat-transfer fluid greater than the turbulence generated by the first heat-transfer-fluid flow disruption component or the second average hydraulic diameter is greater than the first average hydraulic diameter.

12. The heat exchanger as claimed in claim 1, wherein the hydraulic diameter increases regularly along the first zone of the channel or the second zone.

13. The heat exchanger as claimed in claim 1, wherein the first zone covers 70% of the total length of the channel.

14. A housing comprising a plurality of walls forming an internal seat and a heat exchanger including a heat exchange body having:
a heat exchange surface intended to be in thermal contact with the electrical and/or electronic element,
a base surface opposite the heat exchange surface,
a flow channel for a heat-transfer fluid formed between the heat exchange surface and the base surface,
the flow channel including:
a first zone having a first heat-transfer-fluid flow disruption component,
a second zone having a second heat-transfer-fluid flow disruption component,
the first heat-transfer-fluid flow disruption component consisting of a plurality of local deformations of the base surface and the second heat-transfer-fluid flow disruption component consisting of a fin arranged between the heat exchange surface and the base surface and forming a plurality of flow paths, with the heat exchanger being positioned inside the internal seat.
